(19) United States
(12) Patent Application Publication
(10) Pub. No.: US 2004/0005243 A1
(43) Pub. Date: Jan. 8, 2004

(54) Patterned supports for testing, evaluating and calibrating detection devices

(76) Inventors: Gregory Mulhern, Branford, CT (US); Stephen Powell, Middletown, CT (US); Darin Latimer, East Haven, CT (US)

Correspondence Address: AGILIX CORPORATION, 2 CHURCH STREET SOUTH, SUITE 401, NEW HAVEN, CT, 06519, US

(21) Appl. No.: 10/384,238

(22) Filed: Mar. 6, 2003

Related U.S. Application Data
(60) Provisional application No. 60/361,715, filed on Mar. 6, 2002.

(51) Int. Cl. G01N 21/00

(52) U.S. Cl. 422/58; 428/195.1

(57) ABSTRACT

Compositions for testing, evaluating and calibrating detection instruments and methods for making such compositions are described. The compositions comprise a testing feature or plurality of testing features wherein the testing feature or plurality of testing features comprise a detectable substance and are used to evaluate the performance of a detection device. The compositions are useful for analyzing detection limits, sensitivity, image resolution, dynamic range and other parameters. They can also be used to compare data generated by different instruments, in different labels, in different labs or with different optics.

### RELATED APPLICATIONS

This application claims the benefit of U.S. Provisional Application 60/361,715 filed on Mar. 6, 2002.

### BACKGROUND OF THE INVENTION

1. Field of Invention

This invention is directed to methods for fabricating patterned supports for testing, evaluating and calibrating detection instruments. This invention is also directed to patterned supports produced by such methods.

2. Description of Related Art

Microarrays include arrays of active spots and are available in a variety of forms. Generally, detection of analytes associated with cognate spots is accomplished using one or more fluorescent labels. The reagents involved in the chemical reactions in the active spots of the array are typically biological samples such as DNA, RNA, peptides, proteins or other organic molecules. Microarrays can be used for diagnostics, screening assays, genetics and molecular biology research.

Supports comprising microarrays are often processed in a device that illuminates the spots comprising labeled substances with light sources having wavelengths corresponding to the fluorescent labels. The fluorescent emissions are sensed by the device and their intensity is measured. The presence, absence or intensity of fluorescence can provide data relating to the particular parameters of the use in which-the microarray is employed. In uses employing multiple fluorescent labels, the device can separately sense the fluorescent labels, and thereby provide image maps of the array, showing one or more of the fluorescent labels. The maps are ultimately analyzed to provide meaningful information to the user.

In order to obtain accurate information from the interrogation of a microarray, it is important that the device functions properly and is calibrated to the parameters of the applicable use. If more than one device is employed, it is preferred that the scanning devices provide consistent data.

In conventional microscopy, testing or calibrating targets are employed to evaluate system performance of conventional microscopes. These targets are used to establish a baseline between different microscope systems and to characterize image quality in terms of its conventional components: resolution, contrast, depth of field and distortion. The targets are typically printed or vapor deposited patterns on plastic or glass supports. The optical features on the target are preferably finer than the resolution of the optical system being tested.

For testing or calibrating targets for fluorescence microscopy, besides the numerous conventional components of image quality, the optical efficiency of the system with respect to the particular fluorescent labels must also be tested. Without the desired degree of calibration, it becomes difficult to compare the results obtained from biological testing, research or other uses performed with the same instrument utilizing different fluorescent labels, or to differentiate between results obtained on different instruments, thus creating serious difficulties in comparing and coordinating the results of different uses, or of different iterations within the same use.

A number of tactics for calibrating detection devices have been suggested. One such technique uses a layer of organic fluorescent material deposited on a non-fluorescent glass support, such as synthetic quartz. A suitable pattern is then etched into the fluorescent material, so that the critical edges of the reference are defined by the exposed edges of the fluorescing material. One shortcoming of this technology is the cost of the processing.

Another technique for testing or calibrating a fluorescent microscope uses a device comprising a thin metal layer deposited on a fluorescent glass slide. According to this method, a nickel layer can be employed. A suitable pattern is subsequently etched in the metal to create fine features. The difficulty with this method is that the glass slide fluoresces over a great thickness. This thickness far exceeds the depth of field in a typical microarray. The fluorescent radiation emitted throughout this thickness makes focusing difficult.

WO 01/59501 discloses a calibration tool for fluorescent microscopy that includes a substrate, a solid surface layer including a fluorescent material, and a thin opaque mask of non-fluorescent material defining reference feature openings having selected dimensions exposing portions of the surface layer. This reference also discloses a second type of calibration tool that includes a thin opaque mask fabricated onto a substrate and a solid surface layer, including a fluorescent material, located on the thin opaque mask.

Patterns of natively fluorescent polymers on glass slides have also been described (#720-75075 from PerkinElmer Life Sciences, FluorIS from CLONDIAG). The pattern is observable due to the native fluorescence of the deposited material. The patterned supports according to this invention include labeling agent(s) for detection rather than using the intrinsic optical properties of polymers, as in these devices.

### SUMMARY OF THE INVENTION

In spite of these developments, there continues to be a need for a calibration target that adequately simulates the size, arrangement and fluorescent activity of spots in a microarray.

It is also known in the art to test, evaluate or calibrate microarray detection instruments using printed microarrays. Microarrays themselves are used to diagnose problems with color balance, image registry, linearity of signal response, etc. Several inherent problems arise from the use of printed microarrays as evaluation or diagnostic tools.

Printed microarrays used for such purposes are usually spotted with a fluorescently tagged molecule, such as an oligonucleotide or a polypeptide. Arrays such as these are subject to inconsistent spot size, inconsistent spot positioning, inconsistent spot volume, and inconsistent density of spotted fluorophores. These problems stem from difficulties arising during fabrication of the printed microarrays, including print positioning due to mechanical tolerance of the system, print quality due to the sample application device, and sample impurity due to chemical synthesis errors. Additionally, the biomaterials are usually attached to the support through some chemical or physical method. The efficiency of the method is often not constant. As described above, a calibration tool is needed for high reliability testing, evaluation and calibration of microarray detection devices.

Accordingly, this invention provides a simple reusable patterned support for conducting low-cost diagnostics and/or quality control of microarray detection devices, in contrast with the problems inherent in microarray spotting devices.

The patterned supports can be used in evaluating multiple detection devices with regard to detection limits, sensitivity, scan speeds, image resolution, dynamic range and other parameters.

The patterned supports can also be used to compare data generated by different instruments, in different labels, in different labs or with different optics.

In addition, data sets compiled in different uses can be compared using patterned supports by comparing the parameters of detection devices used to obtain those data sets.

Furthermore, patterned supports can provide data from detection devices that are useful for the testing, quality control, and development of image processing packages and systems.

In another embodiment, the invention provides methods for making patterned supports comprising applying a layer comprising a polymer and a labeling agent (polymer/labeling agent composition) to a support.

In a preferred embodiment, a non-uniform pattern is formed on the layer. In another preferred embodiment, the pattern is developed using a suitable solvent. A more preferred embodiment of the claimed method comprises all four steps.

These and other features and advantages of this invention are described in or are apparent from the following detailed description of various exemplary embodiments of the systems and methods according to this invention.

### BRIEF DESCRIPTION OF THE DRAWINGS

Various exemplary embodiments of this invention will be described in detail with respect to the following drawings, in which like reference numerals indicate like elements, and wherein:

FIG. 1 is a cross-section view of uniform patterned supports on which a polymer/labeling agent layer has been formed;

FIGS. 2 and 3 are cross-section views of a support and a polymer/labeling agent layer, including a schematic illustration of a photomask. In FIG. 2, the polymer/labeling agent layer behaves as a negative photoresist and in FIG. 3, the polymer/labeling agent layer behaves as a positive photoresist.

FIG. 4 is a plan view of an exemplary embodiment of a photomask used to form an exemplary non-uniform patterned support according to this invention.

FIG. 5 is a plan view of an exemplary embodiment of a non-uniform patterned support according to this invention.

FIG. 6 is a view of uniform patterned supports comprising different concentrations of fluorphores.

FIG. 7 is a graph illustrating the sensitivity of a particular scanning device to two different labeling agents; and

FIG. 8 is a graph illustrating the sensitivity of the scanning device of FIG. 6 to two different labeling agents when calibrated using a scalar figure determined through use of a patterned support according to this invention.

### DETAILED DESCRIPTION OF EXEMPLARY EMBODIMENTS

As described above, the present invention is directed to compositions and methods for testing, evaluating, and calibrating detection devices. Various parameters that can be assessed include detection limit, sensitivity, scan speed, image resolution, dynamic range, as well as other characteristics.

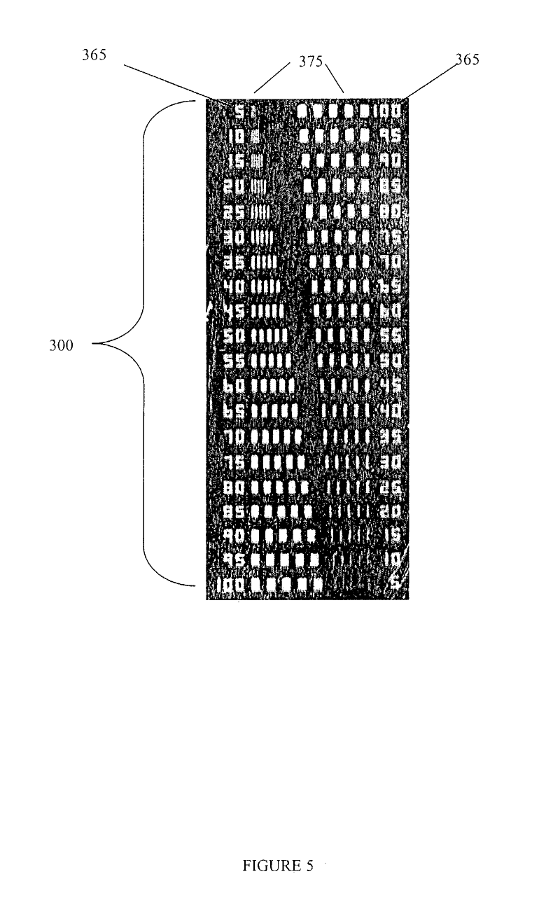

In one embodiment, the invention provides a non-uniform patterned support comprising a plurality of features wherein the features are used for evaluation of a detection device. In some embodiments, the features comprise a non-uniform pattern or patterns of detectable substance on the support. The non-uniform pattern or patterns of detectable substance can be useful to determine the device's ability to resolve images of differing sizes and spacing (see FIG. 5). For example, if it is known that an accurate detection device resolution of 5 microns is essential for the experiments to be performed, a support can be patterned that has features to test the ability of the device to resolve in a range around 5 microns. Choosing the correct instrument based on performance parameters for a customized application can save a researcher valuable time and money. Such supports are of use in confirming that a detection device is operating with the required resolution, or, determining that service of the instrument is required.

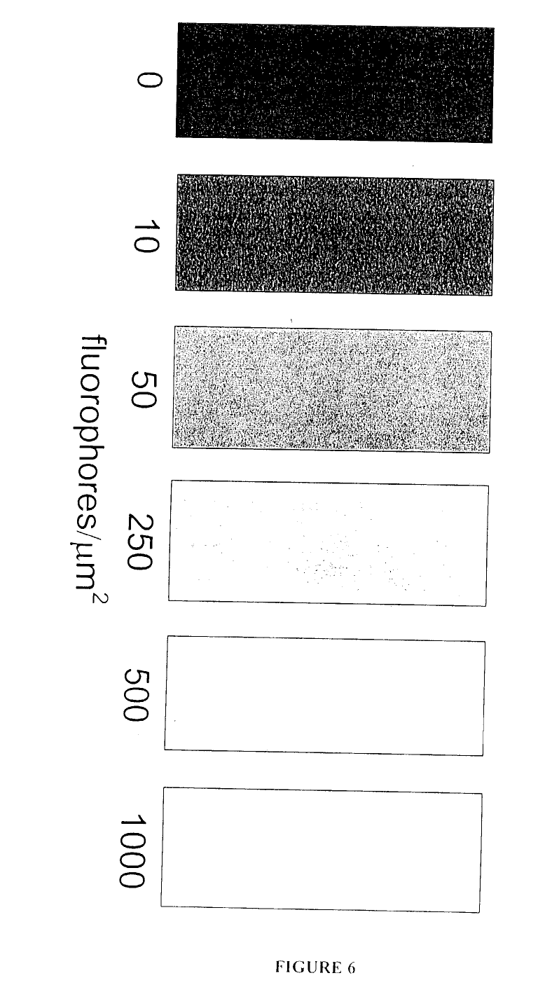

In another embodiment, the patterned supports comprise a single, uniform patterned feature, wherein the feature is used for evaluation of a detection device. In some embodiments, the single feature comprises a known or unknown amount of detectable substance applied on the support in a uniform layer (FIG. 6). Having a plurality of supports each with a different amount of detectable substance can be used for assessing the device's sensitivity and linear range. In other embodiments, the single feature comprises a detectable substance applied on the support in a gradient layer. Thus, the device's ability to detect a substance at various concentrations can also be assessed.

It will be understood by the skilled artisan that the term “pattern” refers to both a uniform pattern and a non-uniform pattern. As used herein, a uniform pattern describes a patterned support having an uninterrupted layer of polymer/labeling agent composition whereas a non-uniform pattern describes a patterned support having a non-continuous layer of polymer/labeling agent composition.

The present invention also provides methods for making patterned supports. In one embodiment, the method comprises applying a layer comprising a polymer and a labeling agent (herein referred to as a polymer/labeling agent layer) to a support. In another embodiment, the method comprises creating a non-uniform pattern in the polymer/labeling agent layer. In preferred embodiments, the non-uniform pattern is created by exposing the layer to radiation or by direct deposition. In other embodiments, the method comprises developing the layer to reveal the pattern.

Supports used in the compositions and methods of this invention include any support useful for a given detection application. In various exemplary embodiments, the material the supports are comprised of can include, but are not limited to, acrylamide, cellulose, nitrocellulose, glass, fused silica, quartz, polystyrene, polyethylene vinyl acetate, polypropylene, polymethacrylate, polyethylene, polyethylene oxide, polysilicates, polycarbonates, teflon, fluorocarbons, nylon, silicon rubber, polyanhydrides, polyglycolic acid, polylactic acid, polyorthoesters, polypropylfumerate, collagen, glycosaminoglycans, polyamino acids, metals, semiconductors, insulators, and any combination of two or more of these materials.

The supports employed in the compositions and methods of this invention can take any form that is compatible with the devices that the supports are to be used with. In various exemplary embodiments, the supports are in a form comprising thin films, membranes, beads, bottles, dishes, fibers, woven fibers, shaped polymers, particles, microparticles, wafers, and slides. In a preferred embodiment, the support is in the form of a slide, such as a microscope slide.

It should be appreciated that the term “support” does not connote any particular form. It should also be appreciated that the term “support,” as used in this description, refers to the physical structure upon which a layer comprising a polymer and a labeling agent can be applied. The support can include intermediate layers.

The supports employed in the methods and compositions according to this invention are limited only to the extent that they must be suitable for use with a detection device. Thus, the support can be a traditional structure such as a slide, bottle, well or other structure, as described above. Alternatively, the above-described structures can serve as supports for the supports according to this invention. In embodiments employing such supports, the support can be a thin film or other suitable layer formed over a slide or other structure. Such thin films or other layers are limited only to the extent that they, like all supports according to this invention, must be suitable for use with a detection device.

In the methods and compositions encompassed by this invention, a layer comprising a polymer and an even or approximately even distribution of a labeling agent is applied to the support. In some such embodiments, the polymer/labeling agent layer is formed from a polymer. The polymer can be any known or later-developed polymer that is suitable for forming a layer on any of the above-described supports. In various exemplary embodiments, the polymer can include, but is not limited to, polymethylmethacrylate (PMMA), polycarbonate (PC), polymethylglutarimide (PMGI) and various copolymers of these polymers.

In some embodiments, the polymer/labeling agent layer comprises one or more labeling agents. The labeling agent can be any known or later-developed labeling agent that can be uniformly distributed within the polymer. In various exemplary embodiments, the labeling agents are fluorescent molecules, such as one or more fluorophores. In some such embodiments, the fluorophores can be fluorescently-tagged phosphoramidites. It should be appreciated by the skilled artisan that the labeling agents can be dissolved into the polymer layer or be covalently bound to the monomer, polymer precursor, polymer, or copolymer.

Many suitable labels for incorporating into, coupling to, or associating with various substances are known. Examples of labels suitable for use in the disclosed methods and compositions include, but are not limited to, radioactive isotopes, fluorescent molecules, phosphorescent molecules, bioluminescent molecules, quantum dots, enzymes, antibodies, and ligands. In some embodiments of the methods and supports according to this invention, mass labels can be employed as labeling agents. Mass labels are compounds or moieties that have, or which give the labeled component, a distinctive mass signature in mass spectroscopy. Such mass labels are disclosed, for example, in WO 02/14867, incorporated herein by reference in its entirety. Mass labels can be detected by mass spectroscopy. Combinations of labels can also be employed according to this invention. The labeling agent can be suspended or embedded in the polymer by any known or later-developed method, so long as an even distribution of the labeling agent through the polymer is achieved.

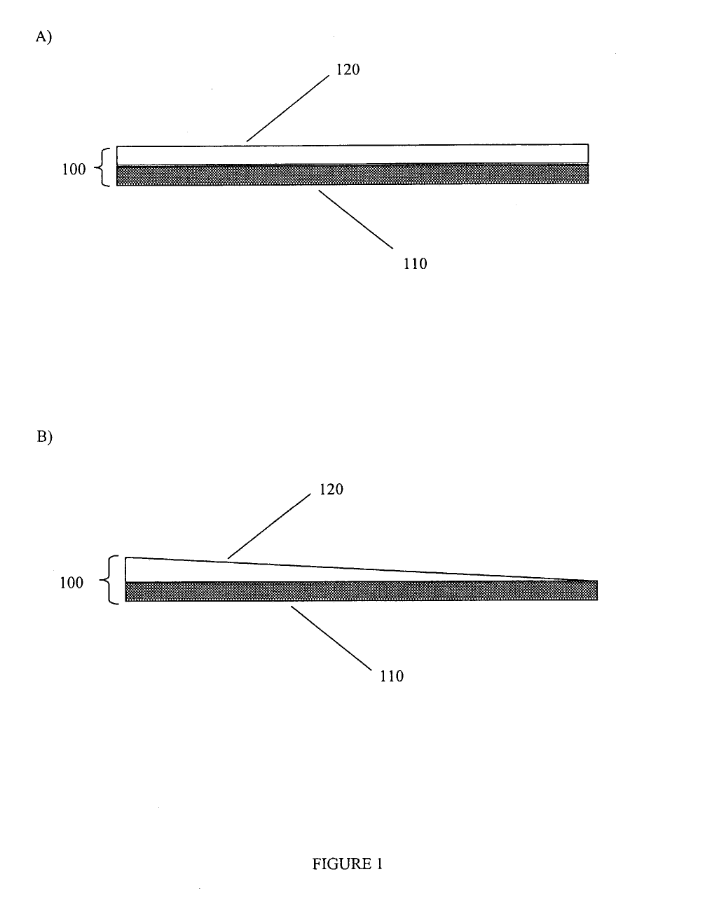

As described above, various embodiments of patterned supports include supports having a single uniform patterned feature. In such embodiments, a detectable substance is applied to the support in either an even layer or a gradient layer. The polymer/labeling agent layer can be applied to the support by any suitable technique. Supports 110 on which a polymer/labeling agent layer 120 has been formed are shown in FIG. 1.

In various exemplary embodiments, a polymer/labeling agent layer 120 of even thickness comprising a polymer/labeling agent composition is formed on the support 110 (FIG. 1A). The polymer/labeling agent layer 120 can be formed by any known or later-developed method by which a layer of even thickness can be formed. In various exemplary embodiments, the polymer/labeling agent layer 120 is formed by one or more of Langmuir deposition, physical vapor deposition, plasma spraying, high velocity oxy-fuel (HVOF) spraying, flow coating, spin coating, blade coating, inkjet deposition, pin-spotting, and spray coating. In preferred embodiments, the polymer/labeling agent layer 120 is formed by spin coating or spray coating.

It should be appreciated that the polymer/labeling agent layer 120 can be formed as a layer of even thickness, comprising an equal distribution of labeling agent. For the purposes of this application, the phrases “even thickness” and “equal distribution” shall describe any polymer/labeling agent layer 120 having thickness and labeling agent distribution of sufficient evenness and homogeneity, respectively, to perform the testing, evaluation and calibrating functions described herein.

In other various exemplary embodiments, a polymer/labeling agent layer 120 of varying thickness comprising a polymer and labeling agent is formed on the support 110 (FIG. 1B). The polymer/labeling agent layer 120 can be formed by any known or later-developed method by which a layer of varying thickness can be formed. In various exemplary embodiments, the polymer/labeling agent layer 120 is formed byflow coating, roll coating, or blade coating.

The thickness of the polymer/labeling agent layer 120 on the final patterned support 100 is dependent on the thickness of polymer/labeling agent layer 120 formed during processing. While the polymer/labeling agent layer 120 can be formed to any suitable thickness, in various exemplary embodiments, the polymer/labeling agent layer 120 can be applied to a thickness of from about 0.1 μm to about 10 μm. The polymer/labeling agent layer 120 will shrink significantly if subsequently baked to remove any solvent, and such shrinkage should to be taken into account in determining the thickness of the polymer/labeling agent layer 120 at formation.

It should be appreciated that, at various stages during execution of the methods according to this invention, the “polymer”/labeling agent layer can include monomers, polymer precursors, polymers, copolymers, and other compositions including repeating units or precursors to such compositions. When a monomer, polymer precursor or polymer composition is added to the support to form the polymer/labeling agent layer, the composition can include one or more additives. The additives can include compositions affecting various characteristics of the monomer, polymer precursor or polymer. In various exemplary embodiments, additives include anti-oxidation molecules. The anti-oxidation molecules can be employed to scavenge oxygen in the polymer/labeling agent layer. Alternately or in addition, small molecules can be added to fill free volume in the polymer and thus reduce oxygen diffusion into the polymer/labeling agent layer.

Other embodiments of the methods and compositions described herein include non-uniform patterned supports comprising a plurality of features. In various exemplary embodiments, the plurality of features comprises patterns of a detectable substance, such as a polymer/labeling agent layer.

In various exemplary embodiments of the methods according to this invention, a non-uniform pattern is formed in the polymer/labeling agent layer by exposing it to radiation. In a preferred embodiment, a high resolution non-uniform pattern is formed on the support by employing a photomask. The photomask includes features that selectively permit exposure of the support to radiation.

The non-uniform patterned supports can comprise a polymer/labeling agent layer that is a positive resist composition or a negative resist composition. Preferentially selecting a polymer/labeling agent layer that is either a positive resist composition or a negative resist composition can depend on a variety of attributes including materials requirements, dimensional resolution requirements, film thickness, and/or other properties.

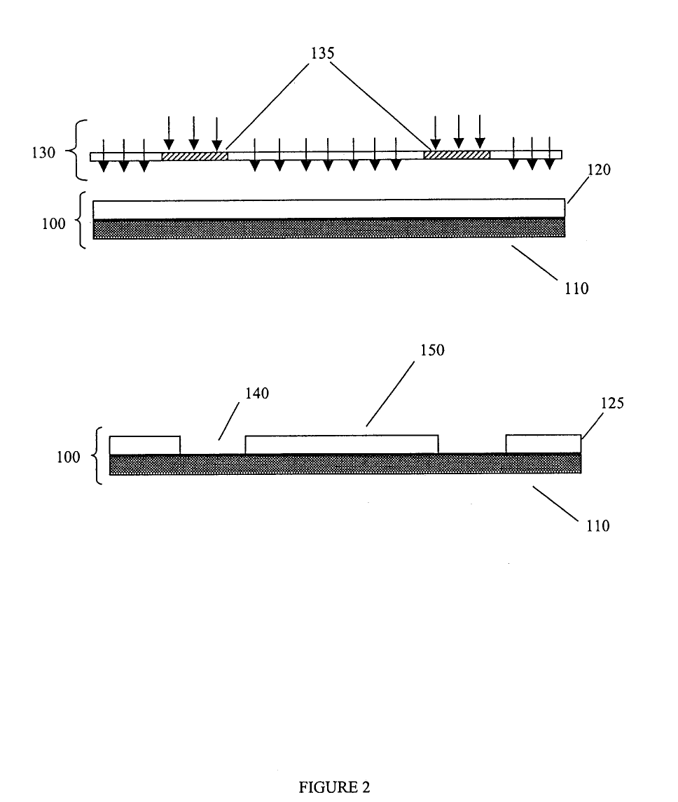

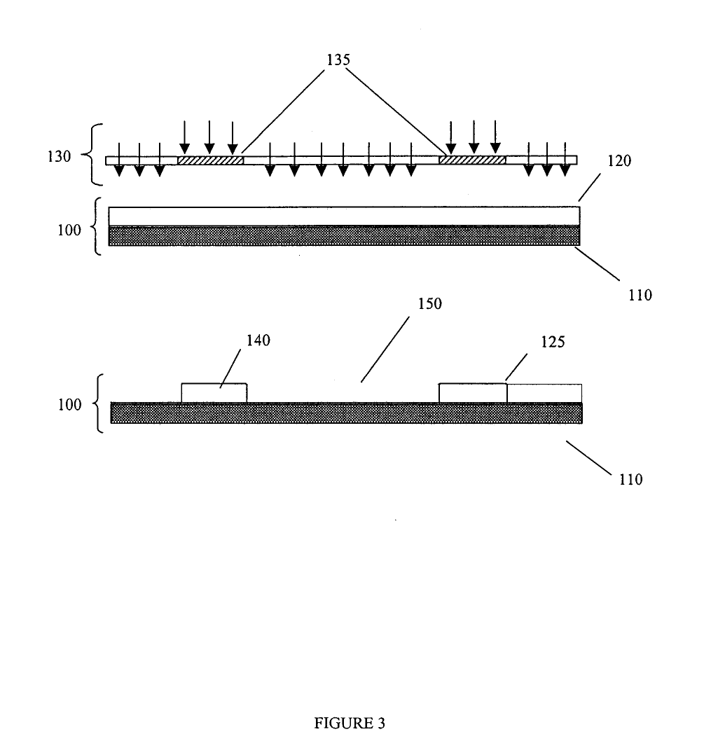

In various exemplary embodiments, if the polymer/labeling agent layer is a positive resist, sections of the support that are blocked from exposure to the radiation retain the polymer/labeling agent film (FIG. 2). In other exemplary embodiments, if the polymer/labeling agent layer is a negative resist, sections of the support that are exposed to the radiation retain the polymer/labeling agent film (FIG. 3). The pattern on the support can be formed using any known or later-developed type of mask. In various exemplary embodiments, the mask is chromium on quartz or fused silica.

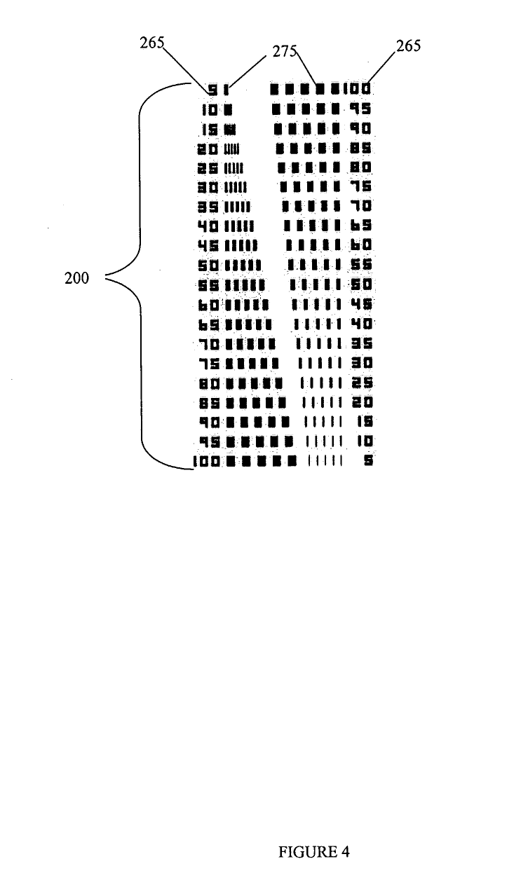

Any mask suitable for forming features required for testing, evaluating and/or calibrating a desired detection device can be used. An exemplary mask 200 is illustrated in FIG. 4. A non-uniform patterned support 300 formed using the mask 200 is shown in FIG. 5.

The mask 200 shown in FIG. 4 includes a plurality of features 275 that can be used to evaluate a detection device. The non-uniform patterned support 300 in FIG. 5, likewise, includes a plurality of features 375 patterned on the support using the photomask. In the exemplary embodiments shown in FIGS. 4 and 5, the photomask and resulting nonuniform patterned support comprise identification features 265 and 365, which identify the adjacent features 275 and 375. In this particular embodiment, features 275 and 375 are rectangular in shape, but have a variety of different sizes. On the left side of the mask and support, the features 275 and 375 have a spacing that is identical to their width as indicated by identification features 265 and 365. On the right side of the mask, the features 275 and 375 are spaced equidistant from each other, but vary in width as indicated by the identification features 265 and 365. Each of the features 275 and 375 can be used to test, evaluate or calibrate a device to a particular resolution, correlating with the size of the feature. The configuration of the identification features 265 and 365 and the testing features 275 and 375, shown in FIGS. 4 and 5, are merely exemplary embodiments of masks and non-uniform patterned supports according to this invention. Masks and non-uniform patterned supports having innumerable identification and testing feature shapes, sizes and attributes will be apparent to those skilled in the art.

While the non-uniform patterned support can be fabricated by the photolithography-type procedures described above, it should be appreciated that the non-uniform patterned support can also be formed in the polymer/labeling agent layer using radiation by direct patterning methods, such as electron beam lithography or by directly writing the pattern using laser ablation or ion milling. Such methods are known in the field of electronics manufacturing. In other embodiments, patterns can be formed by direct deposition of the polymer/labeling agent composition and patterning using a fluid ejection system, piezoelectric printing, or laser-assisted polymerization. Other pattern-making techniques include using both negative and positive acting polymers in patterning and/or using polymers with different developers to deposit layers including different labeling agents having different thicknesses on the same support.

In various exemplary embodiments, the above-described patterning methods are employed to form non-uniform patterns on the support that permit testing of a detection device's ability to resolve images of differing size and spacing. It should also be appreciated that, in various exemplary embodiments of the methods according to this invention, polymer/labeling agent layers can be formed and patterned on supports having varying topographies, as well as on supports that are substantially flat.

In various exemplary embodiments of the patterned supports 100 and methods according to this invention, additional layers can be formed on or over the patterned polymer/labeling agent layer 120. In various embodiments, these layers can be uniformly or non-uniformly patterned as well. For example, an additional polymer/labeling agent layer can be formed. Alternatively, a contrast enhancement material (CEM), which aids in forming a particular pattern, can be applied on or over the polymer/labeling agent layer 120 to form a contrast enhancement material layer. Additional materials can be directly coated onto the polymer/labeling agent layer 120 to manufacture the patterned support for various particular purposes, such as providing patterned supports having multiple labeling agents in different layers or particular three-dimensional patterns, so long as the added material does not adversely affect the polymer/labeling agent layer 120, or the ability of the polymer/labeling agent layer 120 to function in accordance with this invention.

As with the polymer/labeling agent layer 120, any additional layers can be applied over polymer/labeling agent layer using any suitable coating technique. In various exemplary embodiments, additional layers can be applied using Langmuir deposition, physical vapor deposition, plasma spraying, high velocity oxy-fuel (HVOF) spraying, flow coating, blade coating, roll coating, inkjet deposition, pin spotting, spin coating and/or spray coating. In various other exemplary embodiments, additional layers can be formed by spin coating or spray coating.

In various exemplary embodiments, after optionally depositing an additional layer over the polymer/labeling agent layer, a non-uniform pattern is created in the polymer/labeling agent layer using a mask having a desired pattern of features.

Applying the polymer/labeling agent layer or layers can also include additional steps, such as heating, cooling, irradiating the support either, prior to, during, or after applying the polymer layer/layers. Further, forming the polymer/labeling agent layer can include applying one or more monomers or other polymer precursors to the support by any of the above described deposition techniques and subsequently polymerizing the applied monomer(s) to form the polymer layer. Such polymerization can be initiated by any number of chemical or environmental factors.

FIGS. 2 and 3 show a support 110 having a uniformly patterned polymer/labeling agent layer 120 aligned relative to a mask 130. The mask 130 includes features 135 that permit the support 100 to be selectively irradiated. As indicated above, the mask 130 can comprise any suitable material, such as chromium on quartz or fused silica. The mask 130 includes features that correspond with the features that are to be formed in the uniformly patterned polymer/labeling agent layer 120 of the patterned support 100. In various exemplary embodiments, the polymer/labeling agent layer 120 behaves as a negative photoresist (FIG. 2). In other embodiments, the polymer/labeling agent layer 120 behaves as a positive photoresist (FIG. 3). The polymer/labeling agent layer is exposed using any suitable light source. In various exemplary embodiments, the polymer/labeling agent layer 120 is exposed using an ultraviolet light. In some such embodiments, the polymer/labeling agent layer 120 is exposed using one or more wavelengths of a mercury lamp, an ultraviolet light emitting device and/or an ultraviolet laser.

In various exemplary embodiments, the exposed polymer/labeling agent layer 125 is subjected to post-exposure heating to stabilize the non-uniform pattern in the polymer/labeling agent layer 125 prior to development. In various exemplary embodiments, the post-exposure bake can be conducted at temperatures of from about 100° C. to about 180° C. and for times from about 5 to about 30 minutes. The post-exposure heating can cause additional shrinkage of the polymer/labeling agent layer 125. This shrinkage should also taken into account in determining the thickness of the uniformly patterned polymer/labeling agent layer 120 initially formed over the support 110.

The non-uniform patterned polymer/labeling agent layer 125 can be developed after exposure to radiation using any suitable chemical that is effective to develop the constituent polymer(s) and labeling agent(s) of the polymer/labeling agent layer 125. In various exemplary embodiments, the exposed polymer/labeling agent layer 125 can be developed with a mixture of isopropyl alcohol and water. In various exemplary embodiments, the exposed polymer/labeling agent layer 125 can be developed in multiple steps, using different solutions or solutions of different concentrations. Subsequent to developing, the developed polymer/labeling agent layer 125 can be washed or rinsed with an appropriate substance. In various exemplary embodiments, the developed polymer/labeling agent layer 125 is rinsed with water. Depending on whether the polymer/labeling agent layer 120 behaves as a positive or negative resist, the development of the exposed polymer/labeling agent layer 125 results in vacant regions 140 or features 150 that are defined by those vacant regions 140.

The polymer and labeling agent layer can be applied as a single layer on the support or as multiple layers. In various exemplary embodiments of the patterned supports, and of methods for making such patterned supports, according to this invention, patterned polymer/labeling agent layers can be formed that provide features of different types, and with a range of thicknesses. In other embodiments, several patterned supports are produced on a single large support, which can then be broken into a number of patterned slides. The slides may or may not be identical in nature. Thus, the invention provides for a method of making several supports at a time. The patterned supports and methods according to this invention permit formation of polymer/labeling agent layers which can comprise multiple labeling agents and have a variety of thicknesses, therefore permitting calibration of detection devices having multiple channels, and/or calibrating depth resolution in detection devices. Thus, a wide variety of detection devices can be tested, evaluated or calibrated with one or only a few such patterned supports 100 according to this invention.

The patterned supports according to this invention are useful in assessing microarray reading devices, such as fluorescent microarray detection devices. Patterns which can be designed to calibrate an instrument to be sensitive to desired parameters are described throughout.

The patterned supports according to this invention can be used to determine the linear range of signal response of a system to different labeling agent concentrations. While such systems are often purported to have particular specifications with respect to the linear range of the instrument, these measurements are contingent upon the light source and detection settings of the system. The patterned supports according to this invention are made with known concentrations of labeling agent per unit of area. Thus, the linear range of a detection device can be measured using different light source and detection settings to optimize the detection device for use in a particular application.

The patterned supports according to this invention can also be used as diagnostic tools. Microarrays often fail during the course of use. The source of such failures is often difficult to diagnose. The patterned supports according to this invention allow a researcher to quickly determine whether the source of the failure is the array detection device that is being employed. Measurements of parameters of the labeling agent, such as fluorescent intensity in the case of fluorophores, can be made prior to and after the experiment to determine whether a detection device retained a constant level of performance during the course of use.

In conjunction with using the patterned supports according to this invention as diagnostic tools, the supports can also be used as routine calibration and quality control tools. The standards created by the patterns on the supports according to this invention are useful for creating production run charts and other quality control programs. The performance of a detection device or other device can be monitored on a periodic basis to determine whether the instrument meets a particular set of minimum performance standards established by the user. Utilization of this feature of the patterned supports according to this invention allows the user to obtain consistent images from the detection device. The patterned supports can also be used to calibrate different detection devices that are being used for the same purpose.

The precision of microarray uses can also be compromised by differences in various parameters of labeling agents. When fluorophores are used as labeling agents, the different quantum efficiencies of various fluorophores and the use of different hardware to detect different fluors can result in error. Various microarray protocols use the ratio of signal intensities from two different fluorophores to determine the relative amounts of the fluor-tagged molecules of interest from different samples. When the same amount of fluorophore molecules are present, different signal intensities will be obtained due to the above-mentioned factors. Patterned supports according to this invention that are formed with mixtures of the labeling agents of interest in a particular use can be used to determine the sensitivity of different channels. The hardware controls of a detection device can then be adjusted to obtain similar sensitivities.

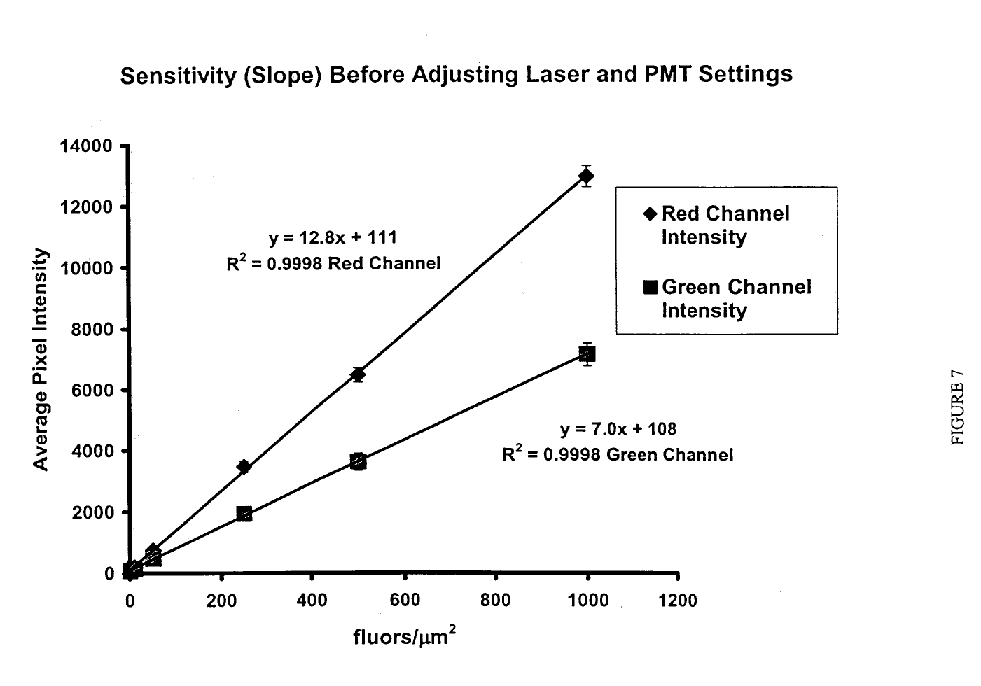

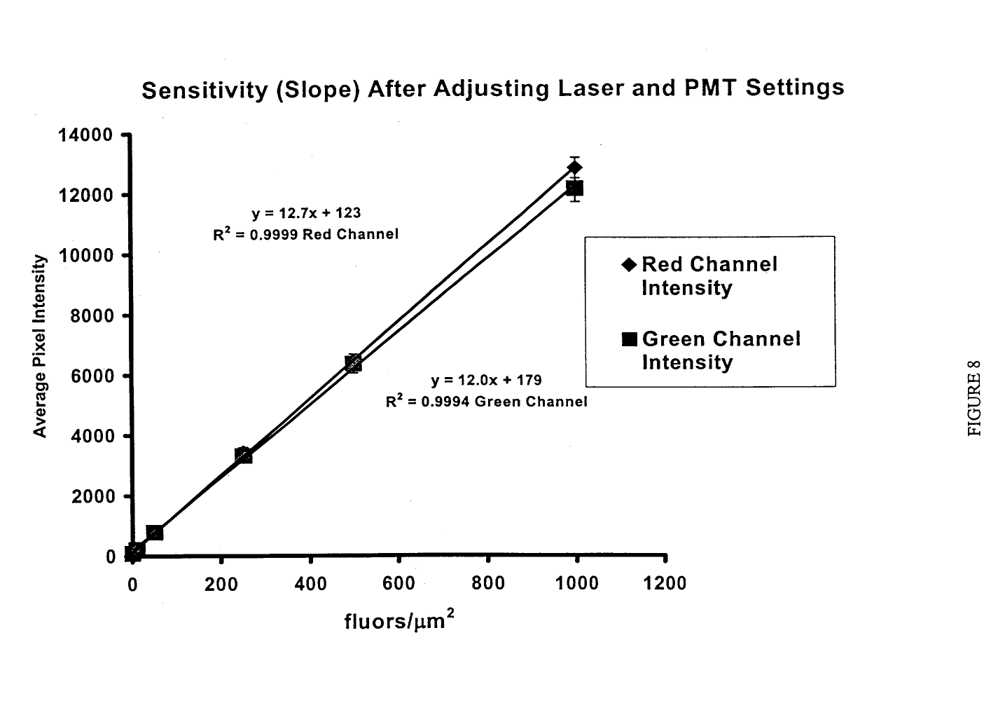

Alternatively, or in conjunction with adjustments to hardware controls, a scalar factor can be determined that compensates for the different sensitivities. FIG. 7 is a graph illustrating the sensitivity of a particular detection device to two different labeling agents. FIG. 8 is a graph illustrating the sensitivity of the same detection device to two different labeling agents using a scalar figure determined by using a patterned support according to this invention. In FIG. 7, the subject detection device has widely different sensitivities for a first labeling agent and a second labeling agent when the detection device's hardware is calibrated to sense both labeling agents in the same manner. By employing a patterned support according to this invention including a polymer/labeling agent layer that includes approximately identical concentrations of each labeling agent, a user can determine the detection device's sensitivity to each labeling agent, and then calculate a scalar factor to compensate for the differing sensitivities. FIG. 8 shows the sensitivity of the detection device to the first and second labeling agents after the calculated scalar factor is used to adjust the detection device's hardware.

Detection devices that detect fluorescent labeling agents can also provide unacceptable results due to crosstalk between channels. When using such devices, within color channels, fluorescent labeling agents have the ability to be excited by wavelengths of light that differ from the absorbance maximum of the particular labeling agent. Thus, labeling agents that are not intended to be visible during a particular detecting step are inadvertently made visible by the incident light used during that detecting step. As a result, the inadvertently illuminated labeling agent emits into the channel under observation. This unwanted emission into the observed channel is known as crosstalk.

Crosstalk can occur to varying degrees, depending upon the hardware and optical settings of a detection device. Crosstalk can also be affected by the performance of the detection device. By employing a patterned support according to this invention including a polymer/labeling agent layer, comprising approximately identical concentrations of each labeling agent, a user can determine the degree to which crosstalk impacts the detection device's sensitivity to each labeling agent. The determinations can be made periodically to evaluate the performance of the detection device. The determinations can also be used to make revisions to readings obtained by the detection device.

It is known to employ beads with surface fluorescent dyes to evaluate or calibrate a fluorescent microscope. The beads can be used to evaluate the two-dimensional or three-dimensional image registration by a detection device. Much in the same fashion, the patterned supports according to this invention can be used to evaluate the two-dimensional or three-dimensional image registration by a detection device. Patterned supports according to this invention that comprise multiple polymer/labeling agent layers of known thickness, each comprising a different labeling agent, allow a user to compare the image registration between images from different channels and to determine the spatial relationships between different labels in a multi-color use.

In various exemplary embodiments, the methods according to this invention can be employed to fabricate patterned identification features on supports used for various purposes. Patterned hydrophobic materials are often deposited on supports to create microwells for aqueous materials on the surface of a support. Many image processing methods rely on a reference feature of the support to properly locate the features on the support for detecting. In practice, it is particularly useful to employ supports which include reference features that occupy identical locations from slide to slide and channel to channel. In various exemplary embodiments, the patterned supports according to this invention include such features.

Many of the exemplary embodiments of this invention, discussed above, are described with respect to fluorescent detection. However, the labeling agents included in the patterned supports according to this invention are not so limited. Any labeling agents that are detectable using any known or later-developed detection technique can be employed in the patterned supports and methods for making fabricated supports according to this invention.

For example, many molecular detection techniques are known and can be used to form the patterned supports according to this invention. In various exemplary embodiments according to this invention, labeling agents include, but are not limited to, labeling agents that can be detected by nuclear magnetic resonance, electron paramagnetic resonance, surface enhanced raman scattering, surface plasmon resonance, fluorescence, phosphorescence, chemiluminescence, resonance raman, microwave and/or mass spectrometry, either alone or in combination. Some such detection techniques are disclosed, for example, in WO 02/14867.

The patterned supports according to this invention can also include features for other types of identification, such as, for example, temporal identification. In various exemplary embodiments, the patterned supports according to this invention can include one or more labeling agents that can be identified temporally with respect to the formation of the patterned support or any other temporal reference point. In some such embodiments, labeling agents can include substances that can be distinguished temporally due to the different fluorescent, phosphorescent and/or chemiluminescent emission lifetimes of constituent element(s). Such labeling agents can be used alone or in combination. As with the pattern features described above, the composition and characteristics of labeling agents should be chosen for their appropriateness to the particular application.

Various exemplary embodiments of the methods and patterned supports according to this invention include fluorescent features that can be used to determine the focus of a detection device. Features containing a labeling agent produce an image at the image plane to be used to adjust focus of the device.

While the patterned supports according to this invention have been described with respect to their utility in detecting applications, and in particular in microarray detecting applications, the patterned supports can be employed in any application where an imaging system is employed. For example, the patterned supports according to this invention can be employed as calibration slides in ultraviolet absorbance readers, such as gel imagers commonly used in biology labs. Gel imaging systems can be used for a number of purposes, including determining the quantity of ultraviolet absorbing molecules, such as oligonucleotides or proteins, in gels, such as polyacrylimide or agarose.

Patterned supports for testing, evaluating or calibrating such systems can be obtained by the above-described fabrication techniques. In various exemplary embodiments, such a patterned support is obtained by employing an ultraviolet absorbing material, such as a chromophore, as the labeling agent in the above-described method. Using an ultraviolet absorbing material as the labeling agent permits users of such absorption based instrument systems to measure the resolution of the system, as well as current performance. Testing, evaluation and/or calibration of absorption based instrument systems, as with other systems, will ensure the production of consistent images by the imaging system.

Further applications of the patterned supports according to this invention include additional identification applications. A patterned support according to this invention can be fabricated that allows the pattern to be transferred to another surface. This transferability can be used to create bar codes for various purposes. Transferability also permits labeling large objects with microspecks. Labeling with microspecks is useful in forensics and clinical testing applications, where it is desirable to provide a small identifier on a large surface.

While the patterned supports can be fabricated using optical labeling agents, such as fluorophores, the methods and patterned supports according to this invention can also encompass mass labeling agents. Patterned supports comprising mass labeling agents can be used to test, evaluate or calibrate various mass-detecting systems, such as matrix-assisted laser desorption ionization (MALDI) systems. MALDI systems generally include wells defined on a MALDI plate that the system samples. Using patterned supports according to this invention comprising mass labeling agents, a certain mass could be defined so that the system is triggered when it scans an area containing the preset mass. In MALDI, this could be used to identify areas that will or will not be sampled. Thus, the possible sampling area could be expanded from predetermined wells to the whole MALDI plate. For example, when examining tissue using a MALDI system, the patterned supports according to this invention could be used to calibrate the system so that only areas including mass-doped tissue are sampled. Thus, the area of interest (scanning area) is defined by the presence or absence of a particular mass dopant.

It will be apparent to the skilled artisan that any number of substances can be incorporated as labeling agents in the methods and patterned supports according to this invention. Various exemplary embodiments of the methods and patterned supports according to this invention have applications including, but not limited to infra-red (IR) spectroscopy, Raman spectroscopy, circular dichroism, phosphorescence, and chemiluminescence imaging.

While this invention has been described in conjunction with the specific embodiments above, it is evident that many alternatives, combinations, modifications, and variations are apparent to those skilled in the art. Accordingly, the preferred embodiments of this invention, as set forth above are intended to be illustrative, and not limiting. Various changes can be made without departing from the spirit and scope of this invention.

We claim:

1. A patterned support comprising a support having a testing feature or plurality of testing features wherein the testing feature or plurality of testing features comprise a detectable substance and are used to evaluate the performance of a detection device.

2. The patterned support of claim 1, wherein the testing feature comprises a detectable substance applied to the support in a uniform pattern.

3. The patterned support of claim 1, wherein the plurality of testing features comprise a non-uniform pattern of detectable substance.

4. The patterned support of claim 2, wherein the detectable substance is applied to the support in an even layer.

5. The patterned support of claim 2, wherein the detectable substance is applied to the support in a gradient layer.

6. The patterned support of claim 1, wherein the detectable substance is a polymer composition comprising a labeling agent (polymer/labeling agent).

7. The patterned support of claim 1, wherein the support is in a form comprising a thin film, membrane, bead, bottle, dish, fiber, woven fiber, shaped polymer, particle, microparticle, wafer, slide or any combination of one or more of said forms.

8. The patterned support of claim 7, wherein the support is in the form of a slide.

9. The patterned support of claim 7, wherein the support is comprised of acrylamide, cellulose, nitrocellulose, glass, fused silica, quartz, polystyrene, polyethylene vinyl acetate, polypropylene, polymethacrylate, polyethylene, polyethylene oxide, polysilicates, polycarbonates, teflon, fluorocarbons, nylon, silicon rubber, polyanhydrides, polyglycolic acid, polylactic acid, polyorthoesters, polypropylfumerate, collagen, glycosaminoglycans, polyamino acids, metals, semiconductors, insulators, or any combination of two or more of these materials.

10. The patterned support of claim 6, wherein the polymer/labeling agent composition comprises polymethylmethacrylate, polycarbonate, polymethylglutarimide, or various copolymers of these polymers.

11. The patterned support of claim 6, wherein the polymer/labeling agent composition comprises monomers, polymers, or polymer precursors, copolymers, other compositions comprising repeating units or precursors to such compositions, or any combination thereof.

12. The patterned support of claim 6, wherein the polymer/labeling agent composition further comprises additional additives.

13. The patterned support of claim 6, wherein the polymer/labeling agent composition comprises one or more labeling agents selected from the group consisting of fluorophores, quantum dots, radioactive isotopes, fluorescent molecules, phosphorescent molecules, bioluminescent molecules, enzymes, antibodies, ligands, mass labels or any combination thereof.

14. The patterned support of claim 13, wherein the labeling agent is a fluorescent molecule.

15. A method for making a patterned support comprising applying a layer comprising a polymer/labeling agent composition onto a support.

16. The method of claim 15, wherein the method further comprises creating a nonuniform pattern in the polymer/labeling agent layer.

17. The method of claim 16, wherein the non-uniform pattern is created by exposing the polymer/labeling agent layer to radiation or direct deposition.

18. The method of claim 17, further comprising developing the polymer/labeling agent layer.

19. The method of claim 15, wherein the support is in a form comprising a thin film, membrane, bead, bottle, dish, fiber, woven fiber, shaped polymer, particle, microparticle, slide or any combination of one or more of said forms.

20. The method of claim 19, wherein the support is in the form of a slide, wherein the slide is a single support or is part of a larger support that is later broken into single supports, wherein the larger support comprises a plurality of single supports that may or may not be identical to each other.

21. The method of claim 19, wherein the support is comprised of acrylamide, cellulose, nitrocellulose, glass, fused silica, quartz, polystyrene, polyethylene vinyl acetate, polypropylene, polymethacrylate, polyethylene, polyethylene oxide, polysilicates, polycarbonates, teflon, fluorocarbons, nylon, silicon rubber, polyanhydrides, polyglycolic acid, polylactic acid, polyorthoesters, polypropylfumerate, collagen, glycosaminoglycans, polyamino acids, metals, semiconductors, insulators, and any combination of two or more of these materials.

22. The method of claim 16, wherein the polymer/labeling agent composition comprises one or more polymers selected from the group consisting of polymethylmethacrylate, polycarbonate, polymethylglutarimide, and various copolymers of these polymers.

23. The method of claim 15, wherein the polymer/labeling agent composition comprises monomers, polymers, polymer precursors, copolymers, other compositions comprising repeating units or precursors to such compositions, or any combination thereof.

24. The method of claim 23, wherein the polymer/labeling agent layer further comprises additional additives.

25. The method of claim 15, wherein the polymer/labeling agent composition comprises one or more labeling agents selected from the group consisting of fluorophores, quantum dots, radioactive isotopes, fluorescent molecules, phosphorescent molecules, bioluminescent molecules, enzymes, antibodies, ligands, mass labels or any combination thereof.

26. The method of claim 25, wherein the labeling agent is a fluorescent molecule.

27. The method of claim 15, wherein the patterned support comprises a uniform pattern, wherein the polymer/labeling agent composition is applied to the support in an even layer.

28. The method of claim 27, wherein the polymer/labeling agent composition layer is applied using a method comprising Langmuir deposition, physical vapor deposition, plasma spraying, high velocity oxy-fuel spraying, chemical vapor deposition, flow coating, spray coating, spin coating or any combination of one or more of said methods.

29. The method of claim 28, wherein the polymer/labeling agent composition layer is applied using spray coating or spin coating.

30. The method of claim 15, wherein the patterned support comprises a uniform pattern, wherein the polymer/labeling composition is applied to the support in a gradient layer.

31. The method of claim 30, wherein the polymer/labeling agent composition is applied using a method comprising flow coating, roll coating, or blade coating.

32. The method of claim 17, wherein the non-uniform pattern on the polymer/labeling agent composition layer is created by exposing the polymer/labeling agent layer to radiation and comprises using a photomask.

33. The method of claim 32, wherein the photomask is comprised of chromium on quartz or fused silica.

34. The method of claim 17, wherein the non-uniform pattern on the polymer/labeling agent composition layer is created by exposing the polymer/labeling agent layer to radiation and comprises using a technique selected from the group consisting of ion milling, electron beam lithography, and laser ablation.

35. The method of claim 17, wherein the non-uniform pattern on the polymer/labeling agent layer is created using a direct deposition and comprises using a fluid ejection system, piezoelectric printing, or laser-assisted polymerization.

36. The method of claim 15, wherein applying the polymer/labeling agent layer onto the support further comprises heating the support, cooling the support, irradiating the support or applying one or more monomers, polymers, or other polymer precursors to the support and subsequently polymerizing the applied monomers, polymers, or polymer precursors.

37. The method of claim 15, further comprising forming additional layer(s) over or on the polymer/labeling agent composition layer.

38. The method of claim 37, wherein the additional layer(s) can be uniformly patterned or non-uniformly patterned.

39. The method of claim 37, wherein the additionally formed layers comprise a contrast enhancement material.

40. The method of claim 17, wherein exposing the polymer/labeling agent layer to radiation comprises using a ultra-violet light source.
